(19) United States
(12) Patent Application Publication
(10) Pub. No.: US 2018/0077216 A1
(43) Pub. Date: Mar. 15, 2018

(54) METHOD AND/OR SYSTEM FOR CREDIT REPORT SHARING

(71) Applicant: Michael Theodore Brown, Walnut, CA (US)

(72) Inventor: Michael Theodore Brown, Walnut, CA (US)

(21) Appl. No.: 15/261,800

(22) Filed: Sep. 9, 2016

(51) Int. Cl. H04L 29/08; H04L 29/06; G06Q 40/02; G06F 17/28; G06F 17/22; G06F 17/27

(52) U.S. Cl. CPC H04L 67/02; H04L 63/08; H04L 67/06; G06F 17/272; G06Q 40/02; G06F 17/289; G06F 17/2247; H04L 67/42

(57) ABSTRACT

A method and/or system is described to prepare and electronically share one or more consumer user credit reports without local storage on an intermediary server.

### BACKGROUND

### 1. Field

This disclosure relates generally to assembly and distribution of credit reports by consumer users.

### 2. Information

In certain types of situations, a credit report (CR) may be requested by a consumer user (CU) for personal use and/or for distribution to support other desired transactions. It is noted that throughout this disclosure, a report, a document and/or similar terms are intended and understood to refer to the foregoing in an electronic form. A CR comprises a record of a consumer's credit history from a number of sources, including banks, credit card companies, collection agencies, and/or governments, for example. A credit history comprises a record of a consumer's responsible repayment of debts. A consumer may fill out an application for credit from a bank, credit card company, a store, etc., which may be forwarded to a credit reporting bureau and/or other credit evaluation provider (CRB). Name, address and/or other identifying content may be compared with content retained by the bureau in its files, e.g., stored on a CRB server. Such records may be supplied to and used by lenders to determine a consumer's credit worthiness; that is, determining an individual's ability and/or track record of repaying a debt. The Fair Credit Reporting Act governs businesses that compile credit reports. These businesses range from three large credit reporting agencies, Experian, Equifax, TransUnion, to specialty credit reporting agencies that cater to specific clients comprising payday lenders, utility companies, casinos, landlords, medical service providers, and/or employers, for example.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration of an embodiment of a system in a networking and/or computing environment;

FIG. 2 is a diagram illustrating an embodiment of a system for credit report sharing;

FIG. 3 is a flow diagram illustrating an embodiment of a method of credit report sharing.

FIG. 4 is a diagram illustrating another embodiment of a system for credit report sharing; and

FIG. 5 is a flow diagram illustrating another embodiment of a method of credit report sharing.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

In some situations, a consumer user (CU) may desire to access and/or receive one or more credit reports (CRs) from one or more Credit Report Providers and/or one or more Credit Bureaus (CRBs). A CU may also desire to display in a relatively easy to read manner one or more CRs provided by one or more CRBs, e.g., to read and/or display in a client side browser on a CU network device (CSBCUND), for example. In this context, the term client side browser refers to a browser executable by a client device. A CU may further desire to share all, or some, content from one or more of the CRs, wherein the to be shared content may be distributed electronically via electronic document to one or more third parties chosen by the CU, e.g., to facilitate one or more transactions. A CU may yet further desire to format the to be shared electronic document in a natural language format as a technique to facilitate distribution, sharing, reading, and/or display. In this context, the term natural language, natural language format and/or similar terms refer to a language that has evolved naturally in humans through use and repetition without conscious planning or premeditation. Natural languages, natural language formats and/or the like may take different forms, including electronic document form, for example. They are, in particular, distinguished from constructed and/or formal languages, such those used in connection with a computing and/or communications network, such as to be compliant and/or compatiable with a standard and/or specification, as discussed in more detail later. An electronic document may employ one of any number of available formats and/or encoding/decoding techniques, which may comprise a natural language format or a non-natural language format, e.g., JavaScript Object Notation (JSON), Extensible Markup Language (XML), Unicode, plaintext, ciphertext, etc., and/or a custom format to be provided to facilitiate encoding, decoding, reading, display, and/or distribution, for example, as discussed in more detail later. It is noted that references to a standard and/or specification, such as protocols for formatting and/or communications, examples of which include: JSON, XML, etc., is intended to refer to any and all versions of the referenced standard and/or specification unless specifically indicated otherwise (e.g., HTML-5). A natural language format may be determined by a particular desire of a CU, convenience for use by third parties receiving a to be shared (e.g., electronic) document, and/or as a result of technical considerations related to distribution of a to be shared credit report, for example.

A challenge to address is that a CRB server may provide a CR in a non-natural language format and/or encoding, whereas a CU, via a CSBCUND, may desire a natural language format electronic document, which may not correspond to a to be provided CR from a CRB server as a result of different formating, different encoding, and/or use of a technique that changes a to be provided CR. For example, non-natural language formats may comprise one or more formats and/or encodings employed by one or more CRs as a technique to provide one or more CRs to a CU, e.g. provided by a CRB server to a CBSCUND. For example, a non-natural language CR may employ JavaScript Object Notation (JSON), Extensible Markup Language (XML), etc., a custom format and/or other encoding.

Yet a further challenge to be addressed is that a CU may desire to receive one or more CRs from more than one CRB. Thus, more than one non-natural language format and/or encoding technique may be involved. However, a CU may desire to display, share and/or otherwise distribute a natural language format document using aspects of multiple CRs, which, therefore, may involve more than one non-natural language format and/or encoding. Thus, a challenge may be presented to translate one or more non-natural language formats and/or encoded CRs to a common and/or consistent natural language format document for display and/or distribution by a CBSCUND.

Another challenge may be to access and/or receive a CR, such that a CSBCUND remains compliant with one or more CRB policies and/or procedures. For example, a CRB policy may be that a CU identity be validated. One non-limiting example of a validation procedure may comprise providing a CU logon identification and password and/or by answering one or more questions provided by a CRB server at the time a CR is to be requested.

One or more CRBs may also have other policies that may result in a further challenge to a CU accessing and/or receiving a CR, particularly if a CU employs a proxy-type device, e.g., an intermediary server (IS). For example, a CRB policy may dictate that a CR be accessed and/or stored by a CU network device, or likewise that an IS may not be employed for direct access to a CR or for local storage of a CR (e.g., on an IS).

It may be yet a further benefit if a CU were able (e.g., capable) of employing a technique to acquire one or more CRs from one or more CRBs so as to assemble and/or display a natural language document to share a document with third parties comprising at least portions of the one or more CRs from the one or more CRBs despite those CRs being made available in different non-natural language formats. It may further be beneficial to be able (e.g., capable) of performing these operations in a relatively easy to use fashion, e.g., by employing a (CSBCUND), so as, for example, to facilitate transactions.

For example, a CU may be a relatively non-technical individual generally unfamiliar with details regarding computing and/or communication networks. Therefore, a CU may have relatively little interest and/or knowledge on how to electronically access credit reports from one or more credit bureaus and/or credit report providers (CRBs). Thus, complexity, due at least in part to one or more of the following, may mean that generating a natural language document, as suggested previously, may exceed the skills of a typical CU. Examples of technical aspects potentially resulting in complexity may include: accessing one or more CRB servers via a browser; providing properly formatted responses to challenge questions employed to verify CU identity so as to enable a credit report (CR) to be provided from one or more CRB servers; handling multiple CRs, the CRs further having possibly multiple formats, and/or updating a web browser technology to be compliant with a relatively recently updated communication and/or content exchange protocol of one or more CRB servers. Further, as previously alluded, a CU may desire to access, display, and/or share one or more CRs in a relatively easy to use natural language format, e.g., share a document in a natural language format, so as to facilitate potential transactions.

Further challenges may comprise difficulty in distributing one or more CRs, being possibly in multiple formats as a result of being from a variety of CRBs. A CU may wish to share a CR with third parties having a variety of access points on a network and/or a variety of communication interfaces, e.g., a CU may wish to communicate one or more CRs, possibly in a natural language format, via email or programmatically via an application programming interface (API), as examples.

It may be desirable for a CU to relatively easily share one or more CRs, e.g., through only a few mouse clicks and/or relatively few interactions with a client side browser (CSB), e.g., respectively comprising a single mouse click on a web browser to request one or more credit reports, answering identity verification questions to access the one more more CRs and/or to initiate sharing in a relatively easy way that also results in display of an easy to read natural language format document to be provided to third parties that a CU may designate.

Furthermore, it may be convenient to reduce occurrence of technical modifications, which may ordinarily frequently occur as a result of web content and/or communication protocol evolution of supporting technology. Thus, it may be a benefit to provide a CU with a relatively easy to use “turn-key”-type method and/or system. For example, a method and/or system, in an embodiment, may assemble, aggregate, and/or otherwise combine multiple CRs possibly with heterogeneous and/or non-native document formats, and facilitate sharing and/or distribution of a natural language document comprising CRs to designated third parties and, thus, possibly improve likelihood of future transactions. For example, a natural language format may be selected by a CU or provided by third parties.

Substantially in accordance with the above stated CU desires and CRB policies, this patent disclosure describes several possible embodiments of a system and/or method, such as an intermediary server, as an example, described in more detail below. In an embodiment, for example, a system may facilitate and/or accomplish access to non-natural language CRs, comply with access policies of one or more CRBs, assemble, display, and/or distribute a document formed from the one or more CRBs, the document in a natural language format, for example, and consistent with CU desires and CRB policies and/or procedures, such as described previously, for example. An intermediary server (IS), in an embodiment, may include a variety of features, such as those described previously and/or described in example embodiments below.

In an embodiment, an IS may include a network services application (NSA) that includes executable instructions for operations to perform one or more interactions with a CU on one hand and one or more interactions with one or more CRB servers on the other hand. For example, an IS may, in an embodiment, provide a CU access to CRs, to be provided by one or more CRBs, and a capability to generate from one or more CRs a natural language document for display and/or distribution.

A client side browser (CSB) may be relatively easy to use for a CU, thus, in an embodiment, providing a technique to achieve the above noted objectives of accessing and/or sharing CRs. However CSB design, use, standards and/or specifications for client-server communication, document encoding, formatting and/or exchange, which may be interrelated at least in part resulting from implementation details, may continue to evolve at times for reasons other than of particular interest to a CU, for example. Thus, potential evolution may result in technical complexity that for one or more of the reasons stated may be at odds with ease of use for a CU. However, in an embodiment, these issues may be resolved in a manner so that a CU may continue to be presented with an easy to use technique, e.g. a CSB that may retain ease of use features while an IS may handle, at times evolving, technical complexity, such as from interacting network devices, e.g., CRB servers having heterogeneous communication and/or format protocols, which may evolve over a period of time.

For example, a CRB may provide a non-natural language format CR as part of request-response interaction(s) with a network device, such as a client side network device. As noted above, such a non-natural format may not be readily compatible with a CU desire to distribute a document in a natural language format to be shared with third parties. An added complication may be that multiple CRBs may provide multiple non-natural formats and/or heterogeneous browser/server communication protocols, as was mentioned. For example, one CRB server may provide a non-natural Javascript Object Notation (JSON) format document and another CRB server may use Extensible Mark Up Language (XML). In another example, asynchronous Javascript and JSON (AJAJ) may be used in one case, and in another case, a CRB server may employ asynchronous JavaScript and XML (AJAX) as a browser/server communication protocol. It is noted that references to a standard and/or specification, such as protocols for formatting and/or communications, examples of which include: JSON, XML, AJAJ, AJAX, etc., is intended to refer to any and all versions of the referenced standard and/or specification unless specifically indicated otherwise (e.g., HTML-5).

A further complication is an evolutionary aspect to development and/or implementation of Web applications, such that not all aspects of particular technologies are necessarily supported. For example, AJAJ and/or AJAX has come to represent a broad group of Web technologies that may be used to implement a Web application, e.g., HyperText Markup Language (HTML) and Cascading Style Sheets (CSS) may be used in combination to mark up and style content for presentation and/or display, where a Document Object Model (DOM) may be accessed with JavaScript to dynamically display—and allow a user to interact with—content presented. JavaScript and XML objects may provide a method for exchanging content asynchronously between a client executed browser and a server without necessarily employing full page reloads. DOM comprises an application programming interface (API) that handles HTML, XHTML, and/or XML content as a tree structure, wherein a node comprises an object representing a part of a document. CSS comprises a style sheet language that may be used for describing presentation of content written in a markup language. For example, a web browser may receive HTML documents from a webserver or from local storage and render them into web pages, JSON or XML may be employed for content format, XSLT for content manipulation, an XML object for asynchronous communication, and JavaScript to integrate these technologies. However, over the years, there have been a number of technologies associated with web or internet development, so that some may not be supported necessarily. For example, XML may not be supported for content interchange and/or format, with JSON used instead as an alternative format.

Thus, such technological evolution may have implementation related drawbacks. As a sampling of examples not meant to be exhaustive, a user whose browser does not support JavaScript, for example, or has this functionality disabled, may not be able to properly use pages that employ AJAX, e.g., simple devices (such as smartphones and PDAs) may not support such technologies. Although a user may potentially fall back to non-JavaScript methods, this may be burdensome in that for proper operation links and/or other forms should be resolved properly, which may introduce additional overhead. Similarly, some web applications that use AJAX may be built in a way that cannot be read by screen-reading technologies. Screen readers that are able to use AJAX may not be able to properly read dynamically generated content, such that AJAX may not be deployed across a wide variety of technical environments. Furthermore, AJAX has an asynchronous nature such that an asynchronous callback-style of programming may lead to complex code that may be a challenge to maintain, to debug, and/or to test. Furthermore, the asynchronous nature of AJAX may lead to greater overhead, such as associated with server polling, which may lead to higher latency with AJAX than may be achieved with other approaches.

In relatively early developed HTML browsers, e.g., before HTML-5, pages dynamically created using successive AJAX requests may not register themselves with a browser's history engine, so clicking a browser's “back” button may not have returned the browser to an earlier page state. If fine-grained tracking of page state is desired, however, a pre-HTML5 workaround may trigger changes in the browser's history, providing another disadvantage. Likewise, for an AJAX supported application, dynamic page updates may disrupt user interactions, particularly if the internet connection is slow and/or unreliable. For example, editing a search field may trigger a query to a server for search completions, but a user may not know that a search completion popup is forthcoming, and if the internet connection is slow, a popup list may show up at an inconvenient time, such as if a user has already proceeded to do something else.

As a result, a variety of technologies continue to evolve and may affect CSB design and use. However, from the perspective of a CU interested in ease of use, complexities are desirably reduced. In one possible approach, as described below, nonetheless, an embodiment may provide an intermediary server between a CU, who desires an easy to use client side browser on a CU network device (CSBCUND), and one or more CSB servers, which may employ a variety of document formats and/or browser/server communication protocols.

However, while various techniques may be employed to achieve a consumer user's objectives of accessing and/or distributing one or more credit reports, there may also be CRB policies, rules, procedures and/or processes to constrain and/or limit access and/or use of a CR, e.g., access to a consumer user (CU) credit report (CR) may be allowed if an appropriate CU identification is validated by a CRB server, for example. Another challenge to address may comprise a CRB policy constraint, such that a server, proxy, or other third party device may not be permitted to store a CRB generated CR. Thus, a CU may be permitted access under appropriate conditions of providing a validated identification, but an intermediary may not readily be provided access and/or permission to locally store a CRB generated CR.

As mentioned above, in one embodiment, an intermediary server (IS) may receive one or more CRs, possibly having a variety of non-natural language formats. Thus, a CU may have relatively easy access to, and/or ability to assemble all or portions of the one or more CRs into an electronic document for distribution. Likewise, such an approach may remain compliant with CRB policies, e.g., comply with a policy that may not allow an intermediary direct access to and/or local storage of a CRB generated CR. Thus, in an embodiment an apparatus and/or method may assemble or otherwise consolidate heterogeneous non-natural language format CRs in a natural language format document, which may be shared with third parties, as designated by a CU, for example.

In an embodiment, a relatively easy to use client side browser (CSB) may be employed to access to one or more CRs from one or more CRBs, generate a natural language format document from the one or more non-natural language CRs, and distribute the generated document as designated by a CU. Furthermore, as mentioned, CRB policies may remain accommodated so that direct access to and/or storage of CRs on an intermediary server does not occur and a CU is able to provide identification validation.

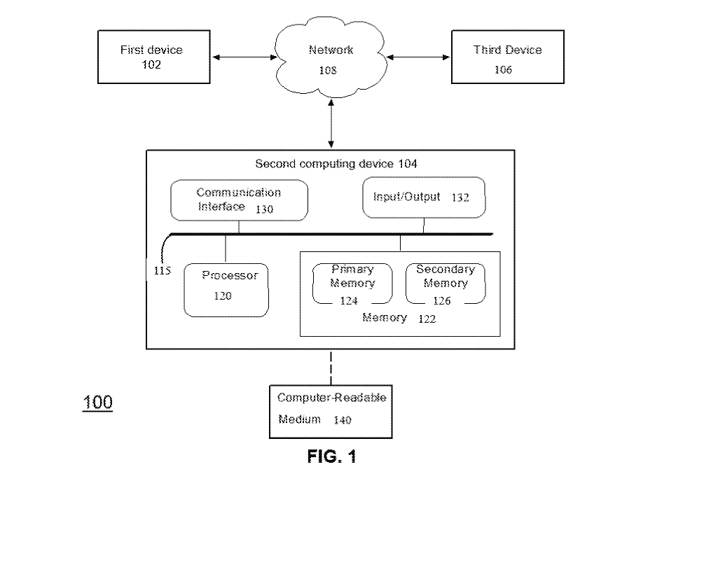

A system for credit report sharing, see, e.g., second computing device 104 in FIG. 1, may be described with reference to a client network device and/or computing device of a CU, see, e.g., first device 102, and with reference to a third device 106, e.g., a Credit Report Provider and/or a Credit Bureau (CRB) server. A CU may electronically share a credit report prepared by one or more Credit Report Providers and/or Credit Bureaus (CRBs) via an intermediary server (IS) 104 without locally storing the credit report (CR) on the IS.

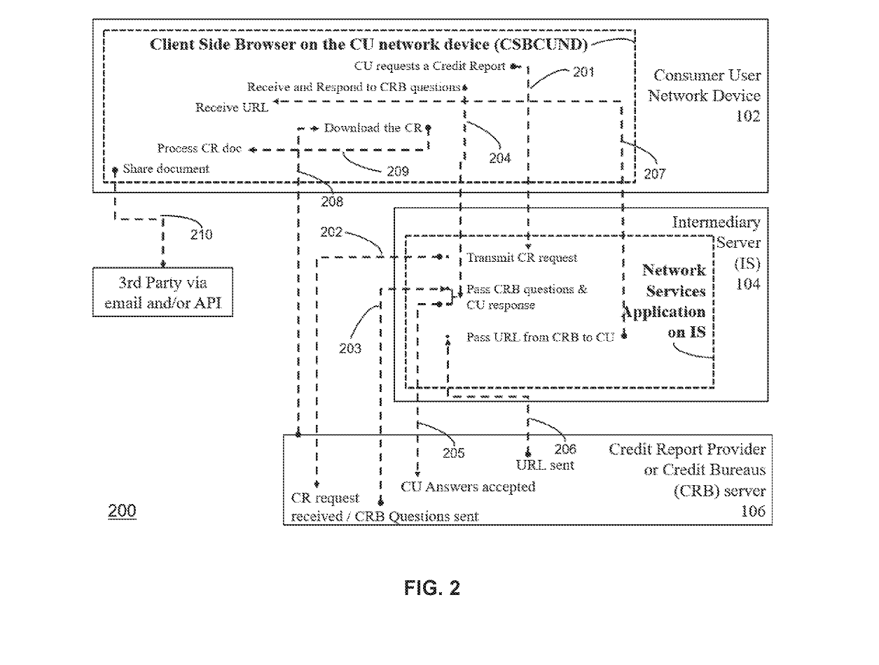

FIG. 2 is a diagram illustrating an embodiment 200 of a system for credit report sharing. Executable instructions may be loaded from IS 104 to a client side browser located on CU device 102. Furthermore, IS 104 executable instructions may comprise a set of instructions that allows a client side browser on consumer user network device 102 (e.g., CSBCUND) to find and read an encoded non-natural language credit report (CR) electronic document in a form suitable for display and/or distribution (e.g., a natural language formatted document).

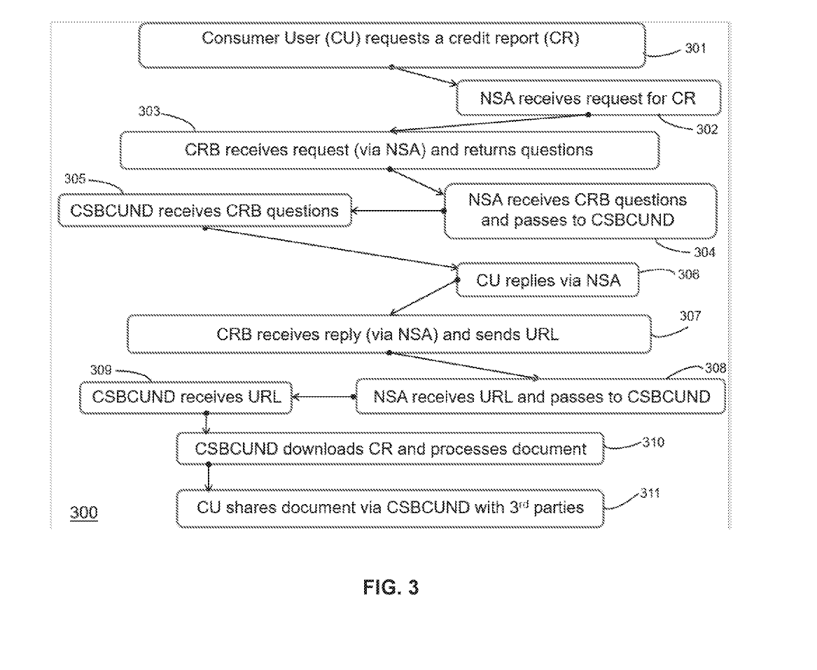

FIG. 3 is a corresponding flow diagram further illustrating an embodiment 300 of a method of credit report sharing, such as may be performed by the embodiment of FIG. 2. Instructions executing a network services application (NSA) on IS 104, for example, may generate a CU electronic request for a CR, e.g., as a result of a CR request by a CU 201 (shown in FIG. 2), in accordance with 301 of FIG. 3. T is noted, of course, that NSA may comprise any executable instructions able to provide a desired amount of network related operations so as to support appropriate communications, such as with a CU network device, and with one or more CRB servers, for example. Referring to this particular, but non-limiting, embodiment, NSA receives a CR request, as shown by 302. As a result of receiving a CR request, NSA sends CR request 202 to CRB server 106. CRB server 106 receives CR request 202 via NSA, as indicated by 303. Thus, CRB server 106 sends questions, such as via communication 203, to be answered by a CU, e.g., addressed to NSA as a result of receiving a CR request. NSA may receive CRB questions via communication 203 from CRB server 106 and pass CRB questions to CSBCUND via communication 204, as also indicated by 304, such that a CU may respond. Thus, CSBCUND may receive CRB questions, as indicated by 305. CRB questions are to be answered (e.g., by a CU), indicated by 306, and are to be returned to validate CU identity, such as may be in accordance with a CRB server process, for example. Thus, in this embodiment, for example, NSA may thus receive answers via communication 204 to CSBCUND, in an embodiment, which may be forwarded via NSA as communication 205 to CRB server 106, as indicated by 307. CRB server 106 may receive CU answers to CRB questions. As a result, CRB server 106 may validate identity. If answers communicated as 205 are validated by CRB server 106, CRB server 106 may send a network link, such as URL, for example, via communication 206, as indicated by 307, for the requested CR, to NSA, e.g., using a network address CRB server 106 associates with identity validation that in this embodiment corresponds to NSA. A typical URL may comprise a protocol (e.g., http), a hostname (e.g., www.CRBservername.com), and a file name (e.g., CRname.html). NSA may receive a URL via communication 206 and pass it to CSBCUND as communication 207, as indicated by 308, such that CSBCUND receives a URL, as indicated by 309. A URL to be associated with the requested CR is therefore to be provided by CRB server 106. In this example, the URL, commonly termed a web address, may reference a web resource, e.g., a CR, may specify a location on a network, e.g., a CRB server address, and a mechanism for retrieving the CR from CRB server 106. Thus, a URL may provide a technique to access an indicated resource, e.g., a CR. A URL may reference web pages (http), but may also be used for file transfer (e.g., an ftp application), email, database access (e.g., a Java Database Connectivity (JDBC) application programming interface), and/or other applications, for example, may be associated with one or more CRB servers. As a result of receiving URL from CRB server 106, CSBCUND may download the CR from CRB server 106 via communication 208. CSBCUND may then process a non-natural language CR, shown as 209 in FIG. 2, as indicated by 310 of FIG. 3, e.g., CSBCUND may load and parse a non-natural language CR to produce a natural language document with some or all non-natural language content of the CR, which may then be stored in memory at CU network device 102, in this example. It is noted, of course, that the foregoing is simply an illustration that is not meant to be limiting. As one example, communications involving questions and answers to validate identity need not take place or be employed.

CSBCUND may further process one or more non-natural language and/or natural language documents similarly fetched from memory of first device 102 as a result of prior operations, similar to the approach discussed above, to produce a combined, concatenated, aggregated, etc. content natural language document that may be shared with third parties. A natural language document may be stored in memory (which may comprise a computer readable medium in some instances) of first device 102 and/or shared with third parties via CSBCUND, as indicated by 311. CSBCUND may include an executable application, e.g., an email application, and/or interface with an API, shown in FIG. 2 as 210, as a technique for sharing a natural language document with third parties. For example, a CU may choose to initiate a share command via CSBCUND, e.g., via a mouse click employing a CSB. A natural language document may also be shared via a CSBCUND programmatic operation implemented as part of a system embodiment (e.g., a natural language formatted document).

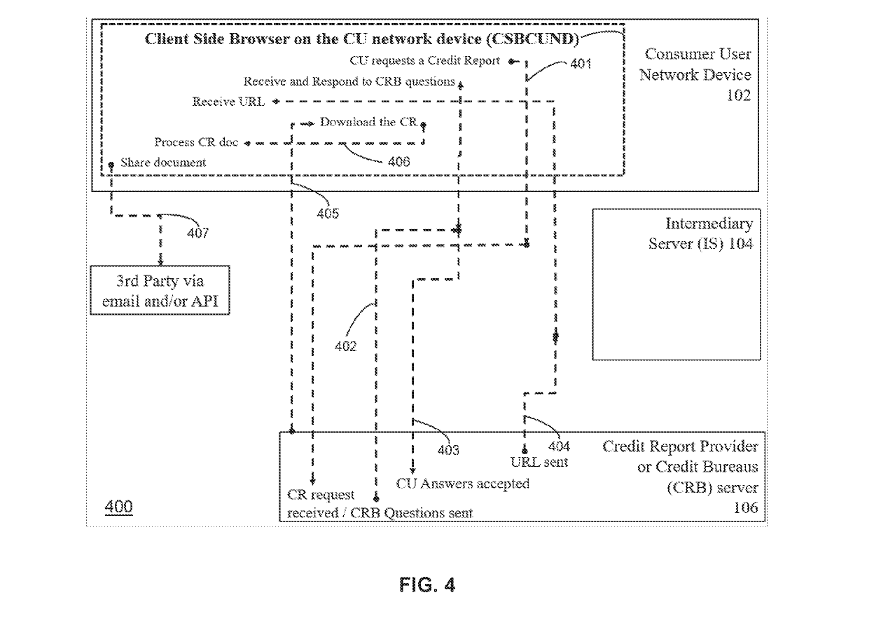

FIG. 4 is a diagram illustrating another embodiment 400. Executable instructions may be loaded from IS 104 to a client side browser (CSB) located on consumer user network device 102. Furthermore, loaded executable instructions may comprise a set of instructions that allows a client side browser on consumer user network device 102 (e.g., CSBCUND) to find and read an encoded non-natural language credit report (CR) electronic document in a form suitable for display and/or distribution.

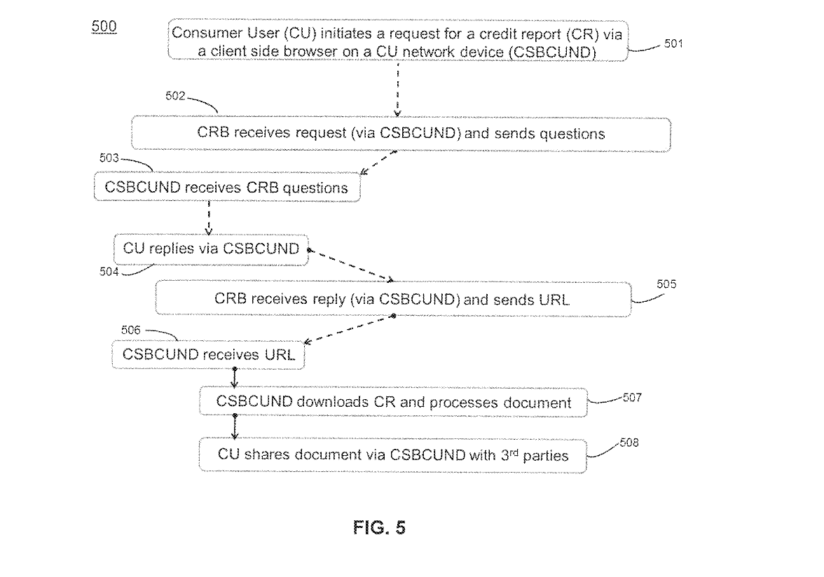

FIG. 5 is a corresponding flow diagram further illustrating another embodiment 500 of a method of credit report sharing, such as may be performed by the embodiment of FIG. 4. Executable instructions, to be loaded, mentioned immediately above, may generate a CU electronic request for a CR, e.g., as a result of a CR request 401 (shown in FIG. 2) by a CU, in accordance with 501 of FIG. 5. CSBCUND may send a CR request 401 to CRB server 106. CRB server 106 may receive a CR request and as a result CRB server 106 may send questions as communication 402, indicated by 502, to be answered by a CU. CSBCUND may receive CRB questions from CRB server 106, as indicated by 503. CRB questions to be answered by a CU are to be returned to validate CU identity in accordance with a CRB server process, for example. Thus, in this example, answers may be forwarded as communication 403 to CRB server 106 via CSBCUND, as indicated by 504. As a result of receiving answers, CRB server is to validate identity. If answers forwarded as communication 403 are validated by CRB server 106, CRB server 106 may send a URL as communication 404, indicated by 505 in FIG. 5, for the CR request. CRB server 106 may associate a network address with CSBCUND. CSBCUND may, through a network address association, receive a network link, such as a URL, for example, as communication 506 from CRB server 106. The URL, for this embodiment, provided by CRB server 106, is to be associated with the requested CR. As a result of receiving the URL from CRB server 106, CSBCUND may download a CR as communication 405 from CRB server 106. CSBCUND may process a non-natural language CR, designated 406 in FIG. 4, as indicated by 507 in FIG. 5, e.g., CSBCUND may load and parse one or more non-natural language CRs to produce a natural language document with some or all non-natural language content of the CR. It is noted, of course, that the foregoing is simply an illustration that is not meant to be limiting. As one example, communications involving questions and answers to validate identity need not take place or be employed.

CSBCUND may further process one or more non-natural language and/or natural language documents fetched from memory as a result of prior operations, similar to the approach discussed immediately above, to produce a combined, concatenated, aggregated, etc. content natural language document that may be shared with third parties. A natural language document may be stored in memory (which may include a computer readable medium in some instances) of first device 102, e.g., CU network device, and/or shared with third parties via CSBCUND, as indicated by 508. CSBCUND may include an executable application, e.g., an email application, or interface with an API, shown in FIG. 4 as 407, as a technique for sharing a natural language document with third parties. For example, a CU may choose to initiate a share command via CSBCUND, e.g., via a mouse click employing CSBCUND. A natural language document may also be shared via a CSBCUND programmatic operation implemented as part of a system embodiment.

The above mentioned embodiments may be implemented using various techniques and/or approaches involving alternate communications for sharing content, as described previously. Furthermore, results may be achieved without local access or local storage of a CR by IS, as desired for an embodiment.

In one example embodiment, as shown in FIG. 1, a system embodiment may comprise a local network (e.g., device 104 and medium 140) and/or another type of network, such as a computing and/or communications network. For purposes of illustration, therefore, FIG. 1 shows an embodiment 100 of a system that may be employed to implement either type or both types of networks. Network 108 may comprise one or more network connections, links, processes, services, applications, and/or resources to facilitate and/or support communications, such as an exchange of communication signals, for example, between a computing device, such as 102, and another computing device, such as 106, which may, for example, comprise one or more client computing devices and/or one or more server computing device. By way of example, but not limitation, network 108 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 1 may comprise features, for example, of a client computing device and/or a server computing device, in an embodiment. It is further noted that the term computing device, in general, whether employed as a client and/or as a server, or otherwise, refers at least to a processor and a memory connected by a communication bus 115. Likewise, in the context of the present disclosure at least, this is understood to refer to sufficient structure within the meaning of 35 §USC 112 (f) so that it is specifically intended that 35 §USC 112 (f) not be implicated by use of the term “computing device” and/or similar terms; however, if it is determined, for some reason not immediately apparent, that the foregoing understanding cannot stand and that 35 §USC 112 (f) therefore, necessarily is implicated by the use of the term “computing device” and/or similar terms, then, it is intended, pursuant to that statutory section, that corresponding structure, material and/or acts for performing one or more functions be understood and be interpreted to be described at least in the foregoing paragraph [0012] with respect to FIG. 2 of the present disclosure.

Referring now to FIG. 1, in an embodiment, first device 102 may be capable of rendering a graphical user interface (GUI) for a network device and/or a computing device, for example, so that a consumer user (CU)-operator may engage in system use. Device 104 may potentially serve a similar function in this illustration. Likewise, in FIG. 1, computing device 102 (‘first device’ in figure) may interface with computing device 104 (‘second device’ in figure), which may, for example, also comprise features of a client computing device and/or a server computing device, in an embodiment. Processor (e.g., processing device) 120 and memory 122, which may comprise primary memory 124 and secondary memory 126, may communicate by way of a communication bus 115, for example. The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Computing device 104, as depicted in FIG. 1, is merely one example, and claimed subject matter is not limited in scope to this particular example.

For one or more embodiments, a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, Md., 21050-2747), but may include other aspects, such as the Hadoop distributed file system (HDFS) (available from the Apache Software Foundation, 1901 Munsey Drive, Forrest Hill, Md., 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present disclosure, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present disclosure, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present disclosure, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g., signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present disclosure, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present disclosure, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present disclosure, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular disclosure, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, Flickr, and/or Google+, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 1, computing device 102 may provide one or more sources of executable computer instructions in the form physical states and/or signals (e.g., stored in memory states), for example. Computing device 102 may communicate with computing device 104 by way of a network connection, such as via network 108, for example. As previously mentioned, a connection, while physical, may not necessarily be tangible. Although computing device 104 of FIG. 1 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 122 may comprise any non-transitory storage mechanism. Memory 122 may comprise, for example, primary memory 124 and secondary memory 126, additional memory circuits, mechanisms, or combinations thereof may be used. Memory 122 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 122 may be utilized to store a program of executable computer instructions. For example, processor 120 may fetch executable instructions from memory and proceed to execute the fetched instructions. Memory 121 may also comprise a memory controller for accessing device readable-medium 140 that may carry and/or make accessible digital content, which may include code, and/or instructions, for example, executable by processor 120 and/or some other device, such as a controller, as one example, capable of executing computer instructions, for example. Under direction of processor 120, a non-transitory memory, such as memory cells storing physical states (e.g., memory states), comprising, for example, a program of executable computer instructions, may be executed by processor 120 and able to generate signals to be communicated via a network, for example, as previously described. Generated signals may also be stored in memory, also previously suggested.

Memory 122 may store electronic files and/or electronic documents, such as relating to one or more users, and may also comprise a device-readable medium that may carry and/or make accessible content, including code and/or instructions, for example, executable by processor 120 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present disclosure, and generally, is considered to be a self-consistent sequence of operations and/or similar signal processing leading to a desired result. In the context of the present disclosure, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular disclosure, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG, 1, processor 120 may comprise one or more circuits, such as digital circuits, to perform at least a portion of a computing procedure and/or process. By way of example, but not limitation, processor 120 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 120 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 1 also illustrates device 104 as including a component 132 operable with input/output devices, for example, so that signals and/or states may be appropriately communicated between devices, such as device 104 and an input device and/or device 104 and an output device. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli. In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. A method of a consumer user (CU) electronically sharing a credit report (CR) prepared by one or more credit reporting bureaus (CRB) via an intermediary server (IS) without locally storing the CR on the IS, the method comprising:
executing instructions on the IS, wherein the IS includes at least one processor and at least one memory; fetching executable IS instructions from the at least one memory for execution on the IS; and executing the to be fetched executable IS instructions on the at least one processor of the IS;
wherein the IS instructions are executed so as to: generate a CU electronic request for a CR; send the CU electronic request for a CR to at least one CRB server; receive questions from the at least one CRB server, the questions to be answered by the CU; permit the CU to respond to the at least one CRB server questions; send the CU responses to the at least one CRB server; and receive a URL from the at least one CRB server; or
wherein the IS instructions are executed so as to load executable instructions into a client side browser of a CU network device (CSBCUND), the to be loaded executable instructions to: generate a CU electronic request for a CR; send the CU electronic request for a CR to at least one CRB server; receive questions from the at least one CRB server, the questions to be answered by the CU; permit the CU to respond to the at least one CRB server questions; send the CU responses to the at least one CRB server; and receive a URL from the at least one CRB server; and
wherein the IS instructions are executed so as to further load executable instructions into a client side browser of a CU network device (CSBCUND), the to be further loaded executable instructions to:
download an electronic version of the CR in non-natural language format via the URL in the CSBCUND; and process in the CSBCUND the electronic version of the CR in non-natural language format as a natural language format document to be electronically shared by the CU.

2. The method of claim 1, wherein the executable instructions to load into the client side browser of the CU network device (CSBCUND) comprise instructions to: generate a CU electronic request for a CR in the CSBCUND; send the CU electronic request for a CR to at least one CRB server via the CSBCUND; receive questions at the CSBCUND from the at least one CRB server, the questions to be answered by the CU; permit the CU to respond to the at least one CRB server questions via the CSBCUND; send the CU responses to the at least one CRB server via the CSBCUND; and receive the URL at the CSBCUND from the at least one CRB server to download the electronic version of the CR in non-natural language format.

3. The method of claim 1, wherein the URL comprises: a http or https uniform resource identifier; a hostname for the at least one CRB server; and a non-natural language format filename.

4. The method of claim 1, wherein the executable instructions to further load into the client side browser of the CU network device (CSBCUND) comprise instructions further to: fetch the CR in non-natural language format from the at least one memory of the CU network device, wherein the non-natural language format comprises HTML, JSON or XML; load the to be fetched CR in the at least one processor of the CU network device; parse the HTML-, JSON-, or XML-format CR; and store the to be parsed non-natural language CR in the least one memory of the CU network device as a natural language format document.

5. An apparatus comprising:
an intermediary server (IS), the IS comprising at least one processor and at least one memory; the IS to execute IS instructions on the at least one processor, the to be executed IS instructions to be fetched from the at least one memory for execution on the IS, and the IS to store in the at least one memory results to be generated from execution of the IS instructions on at least one processor;
wherein the to be executed IS instructions are to be executed so as to: generate a CU electronic request for a CR; send the CU electronic request for a CR to at least one CRB server; receive questions from the at least one CRB server, the questions to be answered by the CU; permit the CU to respond to the at least one CRB server questions; send the CU responses to the at least one CRB server; and receive a URL from the at least one CRB server; or
wherein the to be executed IS instructions are to be executed so as to load executable instructions into a client side browser of a CU network device (CSBCUND), the to be loaded executable instructions to: generate a CU electronic request for a CR; send the CU electronic request for a CR to at least one CRB server; receive questions from the at least one CRB server, the questions to be answered by the CU; permit the CU to respond to the at least one CRB server questions; send the CU responses to the at least one CRB server; and receive a URL from the at least one CRB server; and
wherein the to be executed IS instructions are to be executed so as to further load executable instructions into a client side browser of a CU network device (CSBCUND), the to be further loaded executable instructions to: download the electronic version of the CR in non-natural language format via the URL in the CSBCUND; and process in the CSBCUND the electronic version of the CR in non-natural language format as a natural language format document to be electronically shared by the CU.

6. The apparatus of claim 5, wherein the executable instructions to be loaded into the CSBCUND comprises executable instructions to: generate a CU electronic request for a CR in the CSBCUND; send the CU electronic request for a CR to at least one CRB server via the CSBCUND; receive questions at the CSBCUND from the at least one CRB server, the questions to be answered by the CU; permit the CU to respond to the at least one CRB server questions via the CSBCUND; send the CU responses to the at least one CRB server via the CSBCUND; and receive the URL at the CSBCUND from the at least one CRB server to download the electronic version of the CR in non-natural language format.

7. The apparatus of claim 5, wherein the URL comprises: a http or https uniform resource identifier; a hostname for the at least one CRB server; and a filename for the non-natural language format.

8. The apparatus of claim 5, wherein the executable instructions to be further loaded into the client side browser of the CU network device (CSBCUND) comprise instructions further to: fetch the CR in non-natural language format from the at least one memory of the CU network device, wherein the non-natural language format comprises HTML, JSON, or XML; load the to be fetched CR in the at least one processor of the CU network device; parse the HTML-, JSON-, or XML-format CR; and store the to be parsed non-natural language CR in the least one memory of the CU network device as a natural language format document.

9. A method of a consumer user (CU) electronically sharing a credit report (CR) prepared by one or more credit reporting bureaus (CRB) via an intermediary server (IS) without locally storing the CR on the IS, the method comprising:
executing instructions on the IS, wherein the IS includes at least one processor and at least one memory; fetching executable IS instructions from the at least one memory for execution on the IS; and executing the to be fetched executable IS instructions on the at least one processor of the IS;
wherein the IS instructions are executed so as to: generate a CU electronic request for a CR; and receive a network link from the at least one CRB server; or
wherein the IS instructions are executed so as to load executable instructions into a client side browser of a CU network device (CSBCUND), the to be loaded executable instructions to: generate a CU electronic request for a CR; send the CU electronic request for a CR to at least one CRB server; and receive a network link from the at least one CRB server; and
wherein the IS instructions are executed so as to further load executable instructions into a client side browser of a CU network device (CSBCUND), the to be further loaded executable instructions to:
download the electronic version of the CR in non-natural language format via the network link in the CSBCUND; and process in the CSBCUND the electronic version of the CR in non-natural language format as a natural language format document to be electronically shared by the CU.

10. The method of claim 9, wherein the network link comprises a URL.

11. The method of claim 10, wherein the URL comprises: a http or https uniform resource identifier; a hostname for the at least one CRB server; and a filename for the non-natural language format.

12. The method of claim 9, wherein the non-natural language format comprises at least one of: JSON, HLTM or XML.

13. An apparatus comprising:
an intermediary server (IS), the IS comprising at least one processor and at least one memory; the IS to execute IS instructions on the at least one processor, the to be executed IS instructions to be fetched from the at least one memory for execution on the IS, and the IS to store in the at least one memory results to be generated from execution of the IS instructions on at least one processor;
wherein the to be executed IS instructions are to be executed so as to: generate a CU electronic request for a CR; send the CU electronic request for a CR to at least one CRB server; and receive a network link from the at least one CRB server; or
wherein the to be executed IS instructions are to be executed so as to load executable instructions into a client side browser of a CU network device (CSBCUND), the to be loaded executable instructions to: generate a CU electronic request for a CR; send the CU electronic request for a CR to at least one CRB server; and receive a network link from the at least one CRB server; and
wherein the to be executed IS instructions are to be executed so as to further load executable instructions into a client side browser of a CU network device (CSBCUND), the to be further loaded executable instructions to: download the electronic version of the CR in non-natural language format via the network link in the CSBCUND; and process in the CSBCUND the electronic version of the CR in non-natural language format as a natural language format document to be electronically shared by the CU.

14. The apparatus of claim 13, wherein the network link comprises a URL.

15. The apparatus of claim 14, wherein the URL comprises: a http or https uniform resource identifier; a hostname for the at least one CRB server; and a filename for the non-natural language format.

16. The apparatus of claim 13, wherein the non-natural language format comprises at least one of: JSON, HLTM or XML.

17. An article comprising: a storage medium having stored thereon executable instructions to be executed by an intermediary server, the IS comprising at least one processor and at least one memory;
wherein the instructions to be executed by the intermediary server to: generate a CU electronic request for a CR; send the CU electronic request for a CR to at least one CRB server; and receive a network link from the at least one CRB server; or wherein the instructions to be executed by the intermediary server to load executable instructions into a client side browser of a CU network device (CSBCUND), the to be loaded executable instructions to: generate a CU electronic request for a CR; send the CU electronic request for a CR to at least one CRB server; and receive a network link from the at least one CRB server; and
wherein the instructions to be executed by the intermediary server to further load executable instructions into a client side browser of a CU network device (CSBCUND), the to be further loaded executable instructions to: download the electronic version of the CR in non-natural language format via the network link in the CSBCUND; and process in the CSBCUND the electronic version of the CR in non-natural language format as a natural language format document to be electronically shared by the CU.

18. The article of claim 17, wherein the network link comprises a URL.

19. The article of claim 18, wherein the URL comprises: a http or https uniform resource identifier; a hostname for the at least one CRB server; and a filename for the non-natural language format.

20. The article of claim 17, wherein the non-natural language format comprises at least one of: JSON, HLTM or XML.

21. The method of claim 9, wherein electronically sharing includes electronically sharing with the IS.

22. The apparatus of claim 13, wherein to be electronically shared includes to be electronically shared with the IS.

23. The article of claim 17, wherein to be electronically shared includes to be electronically shared with the IS.
